(19) United States
(12) Patent Application Publication
(10) Pub. No.: US 2024/0021909 A1
(43) Pub. Date: Jan. 18, 2024

(54) BATTERY MODULE

(71) Applicant: SEKISUI POLYMATECH CO., LTD., Saitama (JP)

(72) Inventor: Gaku KITADA, Saitama-shi, Saitama (JP)

(73) Assignee: SEKISUI POLYMATECH CO., LTD., Saitama (JP)

(21) Appl. No.: 18/267,303

(22) PCT Filed: Dec. 17, 2021
(86) PCT No.: PCT/JP2021/046868

§ 371 Date: Jun. 14, 2023

(30) Foreign Application Priority Data
Jan. 29, 2021 (JP) 2021-013715

(51) Int. Cl. H01M 10/653; H01M 50/211; C09K 5/14; C08K 3/22

(52) U.S. Cl. CPC H01M 10/653; H01M 50/211; C09K 5/14; C08K 3/22; C08K 2201/001; C08K 2201/005; C08K 2003/2227

(57) ABSTRACT

The present invention relates to a battery module comprising a case, a plurality of cells arranged in the case, and a heat absorbing member disposed at least either between the case and the cell or between the plurality of cells, wherein the heat absorbing member comprises a silicone matrix and a small particle size aluminum hydroxide having a particle size of 5 μm or less dispersed in the silicone matrix, wherein a content of the small particle size aluminum hydroxide is 20 vol % or more. According to the present investigation, a battery module capable of absorbing a generated heat at 300° C. or less for a long period of time can be provided.

### TECHNICAL FIELD

The present invention relates to a battery module having a specific heat absorbing member.

### BACKGROUND ART

In recent years, electric vehicles have been widespread from the viewpoint of environmental issues. On an electric vehicle, a battery such as lithium ion secondary battery is installed. Since the battery for use in an electric vehicle requires a high output and a high capacity, one battery cell alone is insufficient. Accordingly, a battery module having a combination of a plurality of battery cells, and a battery pack having a combination of a plurality of battery modules are used.

A battery cell generates heat when abnormalities occur such as internal short circuit and damage from outside. The heat transmitting to a neighboring battery cell results in temperature rise to cause a problem of thermal runaway of the whole battery.

From the viewpoint of remedying the problem, in PTL 1, a thermal runaway prevention sheet containing at least one of mineral powder and flame retardant, which initiates an endothermic reaction at 100 to 1000° C. to cause a specific structural change, is described. According to the description, the thermal runaway prevention sheet has thermal insulation performance, so that continuous thermal runaway of a neighboring cell can be prevented.

### CITATION LIST

### Patent Literature

PTL 1: JP 2018-206605 A

### SUMMARY OF INVENTION

### Technical Problem

Although the thermal runaway prevention sheet can suppress the heat transfer to a neighboring cell to a certain extent due to the thermal insulation performance, there is still room for improvement from the viewpoint of sufficiently suppressing rapid heat generation in an initial stage of abnormalities.

In general, a battery module generates heat through a chemical reaction when abnormalities occur such as internal short circuit; and at a temperature of more than about 300° C., a chain reaction is exponentially enhanced, which causes thermal runaway, resulting in firing. Thus, a means for maintaining a temperature at 300° C. or less for a long time, enables the time until thermal runaway to be extended, and as a result, thermal runaway is easily suppressed.

Accordingly, an object of the present invention is to provide a battery module having a heat absorbing member capable of absorbing generated heat at 300° C. or less (for example, generated heat at 200 to 300° C.) for a long period of time.

### Solution to Problem

Through extensive study, the present inventor has found that the problem can be solved by a battery module having a heat absorbing member containing a silicone matrix and aluminum hydroxide having a small particle size in a specific amount, so that the present invention has been completed.

The present invention provides the following described in items [1] to [7].
[1] A battery module comprising a case, a plurality of cells arranged in the case, and a heat absorbing member disposed at least either between the case and the cell or between the plurality of cells, wherein the heat absorbing member comprises a silicone matrix and a small particle size aluminum hydroxide having a particle size of 5 μm or less dispersed in the silicone matrix, wherein a content of the small particle size aluminum hydroxide is 20 vol % or more.
[2] The battery module according to item [1], wherein the heat absorbing member has a thermal conductivity of 0.8 W/mK or more.
[3] The battery module according to item [1] or [2], wherein the heat absorbing member further comprises a large particle size aluminum hydroxide having a particle size of more than 5 μm.
[4] The battery module according to any one of items [1] to [3], wherein a volume ratio of the small particle size aluminum hydroxide relative to the whole amount of aluminum hydroxide contained in the heat absorbing member is 26 vol % or more.
[5] The battery module according to any one of items [1] to [4], wherein a volume ratio of aluminum hydroxide having a particle size of 5 μm or less in the whole aluminum hydroxide contained in the heat absorbing member is 26 vol % or more.
[6] A heat absorbing composition for battery module comprising a curable liquid silicone and a small particle size aluminum hydroxide having a particle size of 5 μm or less dispersed in the liquid silicone, wherein a content of the small particle size aluminum hydroxide is 20 vol % or more.
[7] The heat absorbing composition for battery module according to item [6], wherein the composition is used for a battery module comprising a case and a plurality of cells disposed in the case, and is filled at least either between the case and the cell or between the plurality of cells with a thickness of 0.2 m or more for use.

### Advantageous Effects of Invention

According to the present invention, a battery module having a heat absorbing member capable of absorbing a generated heat at 300° C. or less for a long period of time.

### BRIEF DESCRIPTION OF DRAWINGS

FIG. 1 is a cross sectional view schematically showing an example of the disposition of a heat absorbing member of a battery module.

FIG. 2 is a perspective view showing an embodiment of a cell.

FIG. 3 is a cross sectional view schematically showing another example of the disposition of a heat absorbing member of a battery module.

FIG. 4 is a cross sectional view schematically showing another example of the disposition of a heat absorbing member of a battery module.

FIG. 5 is a cross sectional view schematically showing another example of the disposition of a heat absorbing member of a battery module.

FIG. 6 is an explanatory chart showing an example of assembling of a battery module.

FIG. 7 is an explanatory chart showing another example of assembling of a battery module.

FIG. 8 is an explanatory chart showing an example of assembling of a battery pack.

### DESCRIPTION OF EMBODIMENT

The present invention relates to a battery module comprising a case, a plurality of cells arranged in the case, and a specific heat absorbing member disposed at least either between the case and the cell or between the plurality of cells. The heat absorbing member comprises a silicone matrix and a small particle size aluminum hydroxide having a particle size of 5 μm or less dispersed in the silicone matrix, wherein a content of the small particle size aluminum hydroxide is 20 vol % or more.

An embodiment of the present invention is described with reference to drawings. Incidentally, the present invention is not limited to the content of each drawing described below.

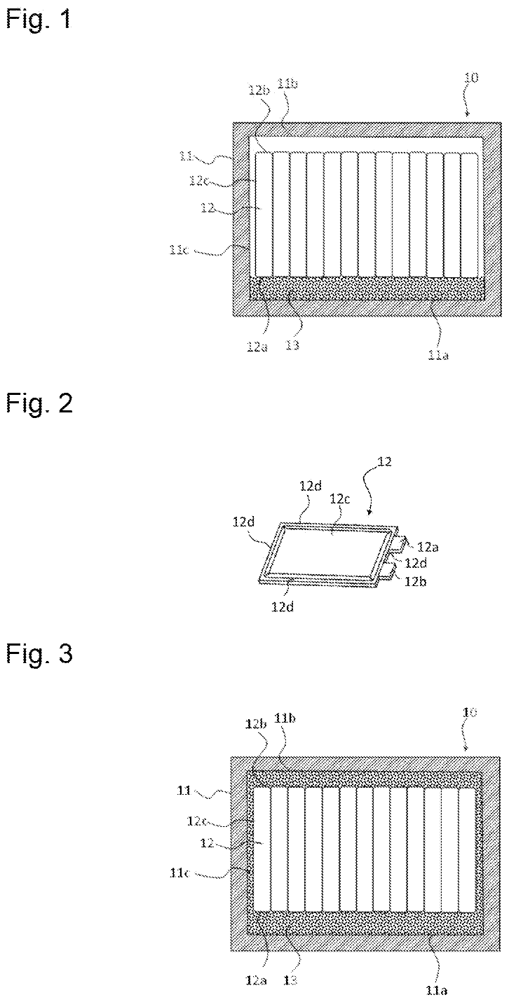

FIG. 1 is a cross sectional view schematically showing an example of the disposition of a heat absorbing member of a battery module of the present invention. A battery module 10 comprises a case 11, a plurality of cells 12 arranged in the case 11, and a heat absorbing member 13 disposed between the case 11 and the cells 12.

The cell 12 is a constituent unit of a lithium ion secondary battery or the like, usually including an exterior packaging film and battery elements encapsulated in the exterior packaging film, which are not shown in drawing. Examples of the battery elements include a positive electrode, a negative electrode, a separator, and an electrolyte solution. As shown in FIG. 2, the cell 12 is in a flat shape with a thickness smaller than the width, having a positive electrode 12a and a negative electrode 12b exposed to the outside, and a flat plane 12c thicker than a crimped edge 12d.

The energy density of a cell 12 is not particularly limited and, for example, 200 Wh/L or more. Due to such a high energy density, the cell 12 may be downsized. On the other hand, it is concerned that the cell 12 tends to become high temperature due to the high energy density in case of abnormality such as a short circuit. The temperature rise of the cell 12 is, however, easily suppressed, because a heat absorbing member 13 is able to absorb a generated heat at 300° C. or less for a long period of time. The higher the energy density of the cell 12, the better, and the energy density is usually 700 Wh/L or less.

In the case 11, a plurality of cells 12 are stacked such that the flat plane comes into contact with each other. Each of the cells 12 is disposed such that the longitudinal direction thereof is in parallel with the vertical direction of the case 11. The case 11 is a member to cover the cells 12 as a whole. The case 11 is made of material having a strength to support a plurality of cells 12, not being deformed by the heat generated from the cells 12. Considering the balance among the strength, the weight, the heat resistance, etc., use of aluminum as the material is preferred.

The heat absorbing member 13 is disposed between a bottom face 11a of the case and a lower edge face 12a of the cell 12. Although the detail is described later, the heat absorbing member 13 contains a certain amount or more of a small particle size aluminum hydroxide having a particle size of 5 μm or less. Accordingly, in case of heat generation due to abnormality of the cell 12 such as an internal short circuit and damage from the outside, the heat absorbing member 13 is able to absorb a generated heat at 300° C. or less for a long period of time, so that the thermal runaway tends to be easily suppressed.

In FIG. 1, an aspect is shown in which the heat absorbing member 13 is disposed between the bottom face 11a of the case 11 and the lower edge face 12a of the cell 12. The disposition of the heat absorbing member 13, however, is not limited to the aspect, and the heat absorbing member 13 may be disposed at least in any space between any face of the case 11 and a face of the cell 12 adjacent to the face of the case 11. Specifically, the heat absorbing member 13 may be disposed between the side face 11c of the case and the flat plane 12c of the cell 12, or between the top face 11b of the case and the upper edge face 12b of the cell 12.

Further, the heat absorbing member 13 may be disposed in the whole space between all of the faces of the case 11 and the face of the cell 12 adjacent to the face of the case 11 (in other words, the whole internal space of the case 11), or as shown in FIG. 3, the heat absorbing member 13 may be disposed to enwrap the whole of cells 12. In that case, the heat generated from the cells 12 can be more effectively absorbed.

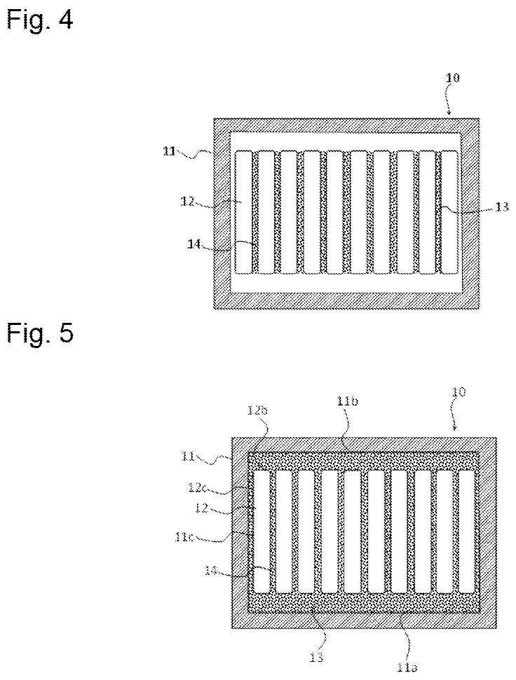

In FIG. 1 and FIG. 3, an aspect is shown in which the heat absorbing member 13 is disposed between the case 11 and the cell 12. Alternatively, the heat absorbing member 13 may be disposed between a plurality of cells 12 (space 14 between cells) as shown in FIG. 4. In this case, the heat absorbing member 13 can suppress the temperature rise in the cell 12 having abnormalities, and the heat transfer at high temperature to a neighboring cell 12 is barely caused, so that the spread of abnormalities can be suppressed. Thereby, the thermal runaway can be effectively suppressed.

Alternatively, the heat absorbing member 13 may be disposed between a plurality of cells 12, in addition to between the case 11 and the cell 12. In FIG. 5, the heat absorbing member 13 is disposed between the plurality of cells 12 and in the whole space between all the faces of the case 11 and the face of the cell 12 adjacent to the face of the case 11 (in other words, the heat absorbing member 13 is disposed in all the internal space of the case 11), so that the temperature rise in the cell 12 can be effectively suppressed, in particular.

In FIG. 1, etc., a laminate-type cell with use of an external packaging film is shown as the cell 12. Alternatively, a square shaped cell or a cylinder shaped cell may be used other than the laminate-type cell.

In FIG. 1, etc., an aspect is shown in which a plurality of cells 12 are stacked in contact with each other. Alternatively, a functional member such as an absorber and a cooling fin may be disposed between the cell 12 and the cell 12.

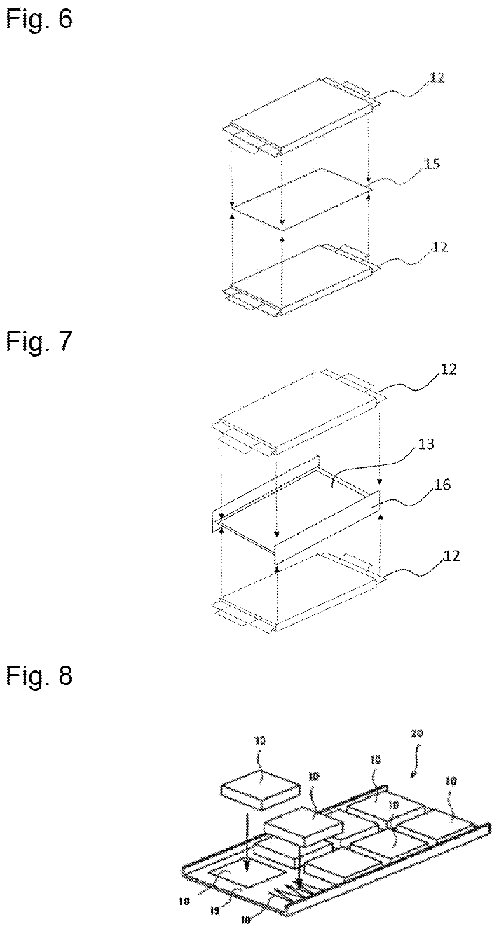

For example, as shown in FIG. 6, a sheet-shaped absorber 15 may be disposed between the cell 12 and the cell 12. Disposition of the absorber 15 improves shock absorption to reduce the occurrence of abnormalities of the cell 12 caused by impact from the outside. Alternatively, a submodule including a plurality of cells 12 stacked, preferably a submodule including two cells 12 stacked, not shown in drawing, may be prepared to dispose the heat absorber 15 between the submodules.

Specific examples of the absorber 15 include a foam and a low-hardness rubber. Only one absorber 15 may be disposed, or two or more absorbers 15 may be disposed.

Also, an embodiment in which an absorber 15 and a heat absorbing member 13 are disposed side by side between a cell 12 and a cell 12, or an embodiment in which a heat absorbing member 13 is disposed between an absorber 15 and a cell 12, is preferred. Thereby, the occurrence of abnormalities in the cell 12 can be reduced, and even when abnormalities occur, temperature rise in the cell 12 can be suppressed, leading to enhanced safety of a battery module.

In the case where the absorber 15 and the heat absorbing member 13 are disposed side by side between the cell 12 and the cell 12, it is preferable that the heat absorbing member 13 be disposed at a place with a larger risk of damage, and the absorber 15 be disposed at another portion. For example, in an embodiment, the absorber 15 is disposed in the vicinity of the center of the cell 12, and the heat absorbing member 13 is disposed in the vicinity of outer edge or corner of the cell 12.

Alternatively, as shown in FIG. 7, a cooling fin 16 may be disposed between the cell 12 and the cell 12. The cooling fin 16 is a member having a sheet and an engaging portion at both edges of the sheet along the longitudinal direction, the member having an H-shaped cross section. Alternatively, a submodule including a plurality of cells 12 stacked, preferably a submodule including two cells 12 stacked, not shown in drawing, may be prepared to dispose the cooling fin 16 between the submodules.

Further, the cooling fin 16 is preferably made of metal, more preferably made of aluminum. By the cooling fin 16, the temperature rise in the cell 12 can be easily suppressed.

Only one cooling fin 16 may be disposed, or two or more cooling fins 16 may be disposed.

Between the cooling fin 16 and the cell 12, a heat-dissipating adhesive or a heat dissipating sheet may be disposed. In particular, it is preferable that a heat absorbing member 13 be disposed between the cooling fin 16 and the cell 12. Thereby, the heat generated in the cell 12 is effectively cooled by the heat absorbing member 13 and the cooling fin 16. Further, the heat generated in the cell 12 is transferred to the case face through the heat absorbing member 13 and the engaging portion of the cooling fin 16 so as to be more effectively dissipated and cooled. Incidentally, the structure of the cooling fin 16 is not limited to the embodiment described above.

[Heat Absorbing Member]

In the following, each of the components contained in the heat absorbing member is described.

<Aluminum Hydroxide>

The heat absorbing member in the present invention contains 20 vol % or more of a small particle size aluminum hydroxide having a particle size of 5 μm or less in a silicone matrix. With a content of the small particle size aluminum hydroxide of less than 20 vol %, a generated heat at 300° C. or less cannot be absorbed for a long period of time, so that thermal runaway is hardly suppressed.

The content of the small particle size aluminum hydroxide in the heat absorbing member is preferably 25 vol % or more, and more preferably 30 vol % or more. Also, from the viewpoints of reducing the viscosity of the heat absorbing composition to make a heat absorbing member for improvement in workability and improving the thermal conductivity with addition of a certain amount or more of a large particle size aluminum hydroxide having a particle size of more than 5 μm, which is described later, the content of the small particle size aluminum hydroxide in the heat absorbing member is preferably 70 vol % or less, and more preferably 50 vol % or less.

It is preferable that the volume ratio of the small particle size aluminum hydroxide relative to the whole amount of aluminum hydroxide contained in the heat absorbing member be 26 vol % or more. Thereby, the generated heat at 300° C. or less is easily absorbed for a long period of time. The volume ratio of the small particle size aluminum hydroxide relative to the whole amount of aluminum hydroxide contained in the heat absorbing member is more preferably 30 vol % or more, still more preferably 40 vol % or more, and furthermore preferably 50 vol % or more. Also, from the viewpoint of enhancing the thermal conductivity with a certain content of a large particle size aluminum hydroxide, the volume ratio of the small particle size aluminum hydroxide relative to the whole amount of aluminum hydroxide contained in the heat absorbing member is preferably 80 vol % or less, and more preferably 75 vol % or less.

The contents of the small particle size aluminum hydroxide having a particle size of 5 μm or less and the large particle size aluminum hydroxide having a particle size of more than 5 μm dispersed in the heat absorbing member are specifically measured as follows. A cross section of the heat absorbing member is observed with an electron microscope (scanning electron microscope, transmission electron microscope, etc.). Based on the observation results, the area ratio of the aluminum hydroxide having a particle size of 5 μm or less in the cross section is defined as the content (vol %) of the small diameter aluminum hydroxide having a particle size of 5 μm or less in the heat absorbing member. Further, the area ratio of the aluminum hydroxide having a particle size of more than 5 μm in the cross section is defined as the content (vol %) of the large diameter aluminum hydroxide having a particle size of more than 5 μm in the heat absorbing member.

Incidentally, the particle size observed with an electron microscope is the diameter of the particle in the case where the observed shape is a circle, or the maximum distance between any two points on the outer periphery of an observed shape in the case where the shape is other than a circle.

It is preferable that the ratio of the aluminum hydroxide having a particle size of 5 μm or less relative to the whole aluminum hydroxide contained in the heat absorbing member be 26 vol % or more. Thereby, a generated heat at 300° C. or less is easily absorbed for a long period of time. The ratio of the aluminum hydroxide having a particle size of 5 μm or less is more preferably 30 vol % or more, still more preferably 40 vol % or more, and even more preferably 50 vol % or more. Also, from the viewpoint of enhancing thermal conductivity by containing a certain amount of the large particle size aluminum hydroxide, which is described later, the ratio of the aluminum hydroxide having a particle size of 5 μm or less is preferably 80 vol % or less, or 75 vol % or less.

The ratio of the aluminum hydroxide having a particle size of 5 μm or less may be determined by observation with an electron microscope (scanning electron microscope, transmission electron microscope, etc.).

It is preferable that the heat absorbing member in the present invention further contain a large particle size aluminum hydroxide having a particle size of more than 5 μm. Due to containing the large particle size aluminum hydroxide, the heat absorbing member has an enhanced thermal conductivity, so that the heat dissipating property may be improved.

The content of the large particle size aluminum hydroxide in the heat absorbing member is preferably 15 vol % or more, more preferably 25 vol % or more, and preferably 60 vol % or less.

(Other Fillers)

The heat absorbing member in the present invention may contain fillers other than aluminum hydroxide. Examples of the other fillers include aluminum oxide, boron nitride, aluminum nitride, silicon carbide, and magnesium hydroxide, and aluminum oxide is preferred in particular. Use of the predetermined aluminum hydroxide and aluminum oxide in combination allows a generated heat at 300° C. or less to be easily absorbed for a long period of time and a heat absorbing member having a high thermal conductivity to be easily obtained.

In the case where aluminum hydroxide and aluminum oxide are used in combination, the volume ratio of aluminum hydroxide to aluminum oxide (Aluminum hydroxide/Aluminum oxide) may be preferably in the range of 0.1 to 10, more preferably in the range of 1 to 5.

The average particle size of aluminum oxide is preferably 0.5 to 150 μm, more preferably 1 to 100 μm, though not particularly limited thereto.

The aluminum hydroxide described above and the fillers other than aluminum hydroxide blended on an as needed basis may be surface treated with a silane coupling agent or the like. Through surface treatment, the ratio of filling to the heat absorbing member may be increased. As the silane coupling agent, any known one may be used without particular limitation, and examples thereof include dimethylmethoxysilane, 3-acryloxypropyltrimethoxysilane, vinyltrimethoxysilane, n-decyltrimethoxysilane, 3-isocyanate propyltriethoxysilane, 3-(2-aminoethyl)aminopropyltrimethoxysilane, 3-mercaptopropyltrimethoxysilane, glycidoxypropyltrimethoxysilane, and 3-phenylaminopropyltrimethoxysilane.

<Silicone Matrix>

The heat absorbing member contains a silicone matrix, and the aluminum hydroxide or the like described above is dispersed in the silicone matrix. It is preferable that the silicone matrix be made of silicone rubber. Use of silicone rubber allows a filler such as aluminum hydroxide to be highly packed, so that the thermal conductivity may be easily enhanced.

It is preferable that the silicone rubber is formed from liquid silicone. Although the liquid silicone may be a liquid silicone having no curability or a curable liquid silicone, a curable liquid silicone is preferred. In the specification, the term “liquid” means being in liquid state at room temperature (25° C.).

Examples of the curable liquid silicone include an addition reaction curable silicone, a radical reaction curable silicone, a condensation reaction curable silicone, a UV-curable or electron beam-curable silicone, and a moisture curable silicone. Among those described above, an addition reaction curable silicone is preferred as curable liquid silicon. As the addition reaction curable silicone, one containing an alkenyl group-containing organopolysiloxane (base resin) and a hydrogen organopolysiloxane (curing agent) is more preferred.

The content of the silicone matrix in the heat absorbing member is preferably 10 vol % or more, more preferably 15 vol % or more, and still more preferably 20 vol % or more, and preferably 70 vol % or less, or 60 vol % or less.

The heat absorbing member may contain resins other than the silicone matrix in a range where the effects of the present invention are not impaired.

Examples of the resins other than the silicon matrix include a rubber and elastomer other than silicone rubber.

Examples of the rubbers other than silicone rubber include an acrylic rubber, a nitrile rubber, an isoprene rubber, a urethane rubber, an ethylene propylene rubber, a styrene-butadiene rubber, a butadiene rubber, a fluorine rubber, and a butyl rubber.

As the elastomer, a thermoplastic elastomer such as a polyester-based thermoplastic elastomer and a polyurethane-based thermoplastic elastomer, and a thermoplastic elastomer formed by curing a polymer composition in liquid state made of mixture of a base resin and a curing agent may be used. Examples thereof include a polyurethane-based elastomer formed by curing a polymer composition containing a polymer having a hydroxyl group and an isocyanate.

The content of the other resins relative to the whole amount of the heat absorbing member is preferably 10 vol % or less, more preferably 5 vol % or less, and still more preferably 0 vol %.

<Thermal Conductivity>

The thermal conductivity of the heat absorbing member is not particularly limited, and preferably 0.8 W/mK or more. With a thermal conductivity of 0.8 W/mK or more, heat is easily transferred from the heat absorbing member to the case or the like, so that the temperature rise of a battery module having abnormalities tends to be suppressed. The thermal conductivity of the heat absorbing member is preferably 1.0 W/mK or more, more preferably 1.5 W/mK or more. Although the upper limit is not particularly limited, the thermal conductivity is preferably 4.0 W/mK or less, more preferably 3.4 W/mK or less, and still more preferably 2.8 W/mK or less.

Thermal conductivity may be measured by a method in accordance with ASTM D5470-06.

Specifically, specimens of heat absorbing member having a thickness in the range of 0.5 mm to 5.0 mm (preferably 1.0 mm to 3.0 mm) are prepared. The thermal resistance is measured for three different thicknesses to calculate the thermal conductivity. The specimens having a different thickness may be prepared separately, or a single specimen may be subjected to measurement with variable compressibility.

[Heat Absorbing Composition for Battery Module]

It is preferable that the heat absorbing member in the present invention be made of heat absorbing composition for a battery module. The heat absorbing composition for a battery module contains a curable liquid silicone and a small particle size aluminum hydroxide having a particle size of 5 μm or less dispersed in the liquid silicone, and the content of the small particle size aluminum hydroxide is 20 vol % or more.

The heat absorbing composition for a battery module preferably contains a large particle size aluminum hydroxide having a particle size of more than 5 μm, and may contain fillers other than aluminum hydroxide. The particle sizes of the small particle size aluminum hydroxide and the large particle size aluminum hydroxide, and the types and particle sizes of the other fillers are as described above. Also, the contents of the small particle size aluminum hydroxide, large particle size aluminum hydroxide, and other fillers in the heat absorbing composition for a battery module are the same as those in the heat absorbing member.

It is preferable that the heat absorbing composition for a battery module be prepared by mixing a curable liquid silicone, an aluminum hydroxide I having an average particle size of 5 μm or less, and an aluminum hydroxide II having an average particle size of more than 5 μm. The average particle size of the aluminum hydroxide I is preferably 4 μm or less, more preferably 3 μm or less, and still more preferably 2 μm or less, and preferably 0.1 μm or more.

Further, in the whole aluminum hydroxide blended as raw material, the content of the aluminum hydroxide I having an average particle size of 5 μm or less is preferably 26 vol % or more, more preferably 30 vol % or more, still more preferably 40 vol % or more, and furthermore preferably 50 vol % or more, and preferably 80 vol % or less, more preferably 75 vol % or less. In the present specification, the average particle size is a value obtained by observation with an electron microscope (scanning electron microscope, transmission electron microscope, etc.), and is the average value of individual particle sizes of a plurality of particles (e.g., 100 particles).

As the curable liquid silicone, the one described above may be used, which is made into a silicone matrix by curing. Accordingly, the content of the curable liquid silicone in the heat absorbing composition for a battery module is the same as the content of the silicone matrix in the heat absorbing member.

The heat absorbing composition for a battery module may contain the silane coupling agent described above, and may also contain additives such as a dispersant, a flame retardant, a plasticizer, a curing retarder, an antioxidant, a coloring agent, and a catalyst.

The heat absorbing composition for a battery module is used for a battery module comprising a case and a plurality of cells arranged in the case, and preferably filled at least either between the case and the cell or between the plurality of cells with a thickness of 0.2 mm or more for use. With use of the heat absorbing composition for a battery module by filling with a thickness of 0.2 mm or more, the effect for suppressing the thermal runaway of the heat absorbing member to be formed tends to be enhanced. The thickness is more preferably 1.0 mm or more and still more preferably 2.0 mm or more. Incidentally, the thickness may be calculated as “Volume of heat absorbing composition filled (mm³)/Total surface area of cell surface of battery module covered with heat absorbing composition (mm²)”.

[Battery Pack]

A battery pack may be made of the plurality of battery modules having the heat absorbing member of the present invention.

FIG. 8 is an explanatory chart showing an example of assembling of a battery pack. A battery pack 20 includes a plurality of battery modules 10, a battery pack housing 19 for accommodating the battery modules 10, and a heat dissipating material 18 disposed between the battery modules 10 and a battery pack housing 19. The battery module 10 is fixed to the battery pack housing 19 through a heat dissipating material 18.

The battery pack housing 19 may be formed of the same material as that of the case 11 described above. The battery pack 20 allows the heat generated from the battery modules 10 to escape to the battery pack housing 19 through the heat dissipating material 18. Thus, the heat generated in the cell 12 is transferred to the heat absorbing member 13, the case 11, the heat dissipating material 18, and the battery pack housing 19, so that the heat dissipation to the outside can be effectively performed. As the heat dissipating material 18, a known material such as a silicone rubber containing a thermally conductive filler such as aluminum oxide, aluminum nitride and boron nitride may be used, or the heat absorbing member of the present invention may be used. With use of the heat absorbing member, a generated heat at 300° C. or less may be absorbed for a long period of time, so that the thermal runaway tends to be easily suppressed.

### EXAMPLES

The present invention is described in more detail with reference to Examples as follows, though the present invention is not limited thereto.

In the present Examples, evaluation was performed by the following method.

[Particle Size]

The content of the small particle size aluminum hydroxide (vol %) in the adsorption member, the average particle sizes (μm) of aluminum hydroxide and aluminum oxide, and the ratio (vol %) of aluminum hydroxide having a particle size of 5 μm or less in the whole aluminum hydroxide contained in the heat absorbing member was determined with a scanning electron microscope (“SU3500” manufactured by Hitachi High-Tech Corporation).

[Thermal Conductivity]

The thermal conductivity of a heat absorbing member was determined by a thermal resistance measurement method with use of a measurement apparatus in accordance with ASTM D5470-06.

A heat absorbing member having a thickness of 1.0 mm compressed to a compressibility of 10% (thickness: 0.9 mm), 20% (thickness: 0.8 mm), or 30% (thickness: 0.7 mm) was subjected to measurement of heat resistance at each of the compressibility (10 to 30%). The three heat resistance values were plotted on a graph with a horizontal axis showing thickness and a vertical axis showing heat resistance, and an approximate straight line passing close to the three points was drawn based on the least-squares method. The inclination of the approximate straight line is the thermal conductivity.

The measurement of heat resistance was performed at 80° C., with LW-9389 manufactured by Long Win Science and Technology Corporation.

[Viscosity]

The viscosity of the heat absorbing composition was measured with a viscometer (“DV2T (spindle: SC4-14)” manufactured by Brookfield) at room temperature (25° C.) at a rotation speed of 10 rpm for 120 seconds. The average value in a period from 90 seconds to 120 seconds was used as the measured value.

[Heat Absorbing Time]

A differential scanning calorimeter (DSC, “DSC-60” manufactured by Shimadzu Corporation) was used to measure the heat absorbing time as follows.

A sample of 40 mg of a heat absorbing member made in each of Examples and Comparative Examples was heated under nitrogen atmosphere from room temperature (25° C.) to 200° C. at a rate of temperature rise of 50° C./min, and then maintained at 200° C. for 10 minutes. The temperature was then raised to 250° C. at a rate of temperature rise of 10° C./min and maintained at a constant temperature of 250° C.

Based on the resulting maximum intensity of the heat absorbing peak, the elapsed time (seconds) from when the temperature reached 250° C. to when the intensity reached 1/10 of the maximum intensity of the heat absorbing peak was defined as the heat absorbing time (seconds). The longer the heat absorbing time is, the longer the period of time over which a generated heat at 300° C. or less can be absorbed.

### Example 1

A heat absorbing composition containing 100 parts by mass of addition reaction curable silicone consisting of a base resin and a curing agent, 170 parts by mass of aluminum hydroxide having an average particle size of 1 m, 430 parts by mass of aluminum hydroxide having an average particle size of 54 m, and 1 part by mass of a silane coupling agent was prepared.

The heat absorbing composition was cured at 25° C. for 24 hours to prepare a heat absorbing member, which was subjected to each evaluation. The results are shown in Table 2.

### Examples 2 to 5 and Comparative Examples 1 to 3

Each of the heat absorbing members was made in the same manner as in Example 1 for each evaluation, except that the composition of the heat absorbing composition was changed as shown in Table 1. The results are shown in Table 2. Incidentally, the viscosity of the heat absorbing compositions in Example 4 and Comparative Example 3 was not able to be measured.

TABLE 1

| | | | | | | | Comparative | Comparative | Comparative |
|---|---|---|---|---|---|---|---|---|---|
| | | Example | Example | Example | Example | Example | Example | Example | Example |
| | | 1 | 2 | 3 | 4 | 5 | 1 | 2 | 3 |
| Heat | Liquid silicone (addition | 100 | 100 | 100 | 100 | 100 | 100 | 100 | 100 |
| absorbing | reaction curable silicone, | | | | | | | | |
| composition | specific gravity: 1) | | | | | | | | |
| (part | Aluminum hydroxide (average | 170 | 200 | 300 | 390 | 300 | 150 | 50 | |
| by | particle size: 1 μm, small par- | | | | | | | | |
| mass) | ticle size, specific gravity: 2.42) | | | | | | | | |
| | Aluminum hydroxide (average | | | | | | | | 300 |
| | particle size: 10 μm, large par- | | | | | | | | |
| | ticle size, specific gravity: 2.42) | | | | | | | | |
| | Aluminum hydroxide (average | 430 | 400 | 300 | 210 | 150 | 450 | 550 | 300 |
| | particle size: 54 μm, large par- | | | | | | | | |
| | ticle size, specific gravity: 2.42) | | | | | | | | |
| | Aluminum oxide (average | | | | | 220 | | | |
| | particle size: 45 μm, specific | | | | | | | | |
| | gravity: 3.9) | | | | | | | | |
| | Coupling agent (specific | 1 | 1 | 1 | 1 | 1 | 1 | 1 | 1 |
| | gravity: 1) | | | | | | | | |

TABLE 2

| | | | | | | | Comparative | Comparative | Comparative |
|---|---|---|---|---|---|---|---|---|---|
| | | Example | Example | Example | Example | Example | Example | Example | Example |
| | | 1 | 2 | 3 | 4 | 5 | 1 | 2 | 3 |
| Composition | Silicone rubber (specific | 100 | 100 | 100 | 100 | 100 | 100 | 100 | 100 |
| of | gravity: 1) | | | | | | | | |
| heat | Aluminum hydroxide | 170 | 200 | 300 | 390 | 300 | 150 | 50 | |
| absorbing | (average particle size: 1 μm, | | | | | | | | |
| member | small particle size, | | | | | | | | |
| (part | specific gravity: 2.42) | | | | | | | | |
| by | Aluminum hydroxide | | | | | | | | 300 |
| mass) | (average particle size: 10 μm, | | | | | | | | |
| | large particle size, | | | | | | | | |
| | specific gravity: 2.42) | | | | | | | | |
| | Aluminum hydroxide | 430 | 400 | 300 | 210 | 150 | 450 | 550 | 300 |
| | (average particle size: 54 μm, | | | | | | | | |
| | large particle size, | | | | | | | | |
| | specific gravity: 2.42) | | | | | | | | |
| | Aluminum oxide (average | | | | | 220 | | | |
| | particle size: 45 μm, | | | | | | | | |
| | specific gravity: 3.9) | | | | | | | | |
| Physical | Aluminum hydroxide (vol %) | 71% | 71% | 71% | 71% | 54% | 71% | 71% | 71% |
| properties | Small particle size aluminum | 20% | 24% | 36% | 46% | 36% | 18% | 6% | 6% |
| | hydroxide (vol %) | | | | | | | | |
| | Ratio of aluminum hydroxide | 28% | 33% | 50% | 65% | 67% | 25% | 8% | 8% |
| | having particle size of 5 μm | | | | | | | | |
| | or less (vol %) | | | | | | | | |
| | Viscosity (Pa · s) | 338 | 450 | 630 | — | 540 | 325 | 270 | — |
| | Thermal conductivity λ | 2.01 | 2.06 | 1.99 | 1.63 | 2.2 | 1.97 | 2.02 | 1.94 |
| | (W/m · k) | | | | | | | | |
| | Heat absorbing time (second) | 3027 | 3047 | 3137 | 3237 | 3247 | 2977 | 2897 | 2857 |

As shown in the results of the above Examples, it has been found that the heat absorbing member containing the small particle size aluminum hydroxide having a particle size of 5 μm or less, wherein a content of the small particle size aluminum hydroxide is 20 vol % or more, has a long heat absorption time of 3000 seconds or more, allowing a generated heat at 300° C. or less to be absorbed over a long period of time. Therefore, a battery module provided with the heat absorbing member in each Example tends to easily suppress thermal runaway.

On the other hand, it has been found that the heat absorbing member not containing 20 vol % or more of the small particle size aluminum hydroxide having a particle size of 5 μm or less in each of Comparative Examples, has a short heat absorption time of less than 3000 seconds, not allowing a generated heat at 300° C. or less to be absorbed over a long period of time. Therefore, a battery module provided with the heat absorbing member in each Comparative Example tends to hardly suppress thermal runaway as compared to those in Examples.

### REFERENCE SIGNS LIST

10: Battery Module
11: Case
11a: Bottom Face
11b: Top Face
11c: Side Face
12: Cell
12a: Positive Electrode
12b: Negative Electrode
12c: Flat Plane
12d: Edge
13: Heat Absorbing Member
14: Space Between Cells
15: Absorber
16: Cooling Fin
18: Heat Dissipating Material
19: Battery Pack Housing
20: Battery Pack

1. A battery module comprising
a case,
a plurality of cells arranged in the case, and
a heat absorbing member disposed at least either between the case and the cell or between the plurality of cells,
wherein the heat absorbing member comprises a silicone matrix and a small particle size aluminum hydroxide having a particle size of 5 μm or less dispersed in the silicone matrix, wherein a content of the small particle size aluminum hydroxide is 20 vol % or more.

2. The battery module according to claim 1, wherein the heat absorbing member has a thermal conductivity of 0.8 W/mK or more.

3. The battery module according to claim 1, wherein the heat absorbing member further comprises a large particle size aluminum hydroxide having a particle size of more than 5 μm.

4. The battery module according to claim 1, wherein a volume ratio of the small particle size aluminum hydroxide relative to the whole amount of aluminum hydroxide contained in the heat absorbing member is 26 vol % or more.

5. The battery module according to claim 1, wherein a volume ratio of aluminum hydroxide having a particle size of 5 μm or less in the whole aluminum hydroxide contained in the heat absorbing member is 26 vol % or more.

6. A heat absorbing composition for battery module comprising
a curable liquid silicone and
a small particle size aluminum hydroxide having a particle size of 5 μm or less dispersed in the liquid silicone, wherein a content of the small particle size aluminum hydroxide is 20 vol % or more.

7. The heat absorbing composition for battery module according to claim 6, wherein the composition is used for a battery module comprising a case and a plurality of cells disposed in the case, and is filled at least either between the case and the cell or between the plurality of cells with a thickness of 0.2 mm or more for use.
